(19) United States
(12) Patent Application Publication
(10) Pub. No.: US 2024/0161172 A1
(43) Pub. Date: May 16, 2024

(54) INFORMATION PUSHING METHOD AND APPARATUS

(71) Applicants: Beijing Wodong Tianjun Information Technology Co., Ltd., Beijing (CN); Beijing Jingdong Century Trading Co., Ltd., Beijing (CN)

(72) Inventors: Bo PAN, Beijing (CN); Meng CHEN, Beijing (CN)

(21) Appl. No.: 18/549,775

(22) PCT Filed: Jan. 5, 2022
(86) PCT No.: PCT/CN2022/070249

§ 371 Date: Sep. 8, 2023

(30) Foreign Application Priority Data
Mar. 11, 2021 (CN) 202110263534.3

(51) Int. Cl. G06Q 30/0601

(52) U.S. Cl. CPC G06Q 30/0631

(57) ABSTRACT

An information pushing method and apparatus. The method includes extracting preference attributes of a user from user dialogue information in the current dialogue scene; determining effective attribute nodes corresponding to the preference attributes in a preconstructed knowledge graph; arranging the effective attribute nodes according to a dialogue time sequence to generate a dialogue path; determining a candidate attribute set and a candidate commodity set on the basis of the dialogue path; using a pretrained strategy prediction model to predict the current pushing strategy on the basis of the current state vector; determining, on the basis of the current pushing strategy, an object to be pushed from the candidate attribute set or the candidate commodity set, and generating, on the basis of said object, information to be pushed; and pushing the information to be pushed.

### CROSS-REFERENCE TO RELATED APPLICATION

This patent application is a national stage of International Application No. PCT/CN2022/070249, filed on Jan. 5, 2022, which claims the priority of Chinese Patent Application No. 202110263534.3, filed on Mar. 11, 2021 and entitled “INFORMATION PUSHING METHOD AND APPARATUS”. Both of the aforementioned applications are hereby incorporated by reference in their entireties.

### TECHNICAL FIELD

Embodiments of the present disclosure relate to the field of computer technology, specifically, to the field of artificial intelligence, and particularly, to a method and apparatus for pushing information.

### BACKGROUND

In the field of electronic commerce, product recommendation systems can recommend products to a user according to preference information of the user for the products, which plays an important role in improving a sales conversion rate.

In related technologies, a product recommendation system mainly includes two types: one is a conventional recommendation model that can determine preferences of the user according to historical behaviors of the user (e.g., browsing, clicking, ordering, etc.), and can actively recommend products to the user; and the other is a dialogue recommendation system that can interact with the user through natural languages, extract the preferences of the user from dialogue information of the user, and then recommend products to the user.

In the related technologies, the dialogue recommendation system maps all preferences of the user obtained from dialogues to a vector space, then take all attributes related to the preferences of the user as candidate attributes, and determine a recommended attribute from the candidate attributes.

### SUMMARY

Embodiments of the present disclosure propose a method and apparatus for pushing information.

Embodiments of the present disclosure provide a method for pushing information, and the method includes: extracting preference attributes of a user for a product from user dialogue information in a current dialogue scenario; determining an effective attribute node corresponding to each preference attribute in a pre-constructed knowledge graph, where the knowledge graph includes attribute nodes, product nodes and edges each connecting an attribute node and a product node, and each edge represents an association relationship between a product node and an attribute node connected by the edge; sorting the effective attribute nodes according to a dialogue time sequence to generate a dialogue path; determining a candidate attribute set and a candidate product set based on the dialogue path, where the candidate attribute set comprises only each adjacent attribute of an effective attribute node at an end of the dialogue path in the knowledge graph, and the candidate product set comprises product information represented by each product node connected to the each effective attribute node; predicting a current push strategy based on a current state vector by using a pre-trained strategy prediction model, where the current state vector is generated based on a dialogue record in the current dialogue scenario, and the push strategy represents pushing attribute querying information or pushing product information to the user at a current time; determining a to-be-pushed object from the candidate attribute set or the candidate product set based on the current push strategy, and generating current to-be-pushed information based on the to-be-pushed object; and pushing the current to-be-pushed information.

In some embodiments, the current to-be-pushed object is determined by: determining a recommendation score of each piece of product information in the candidate product set based on a user embedding vector, an embedding vector of each piece of product information in the candidate product set, and an embedding vector of attribute information represented by each effective attribute node, where the user embedding vector is generated based on a user portrait; determining a recommendation score of each piece of attribute information in the candidate attribute set based on the recommendation score of each piece of product information in the candidate product set and an embedding vector of each piece of attribute information in the candidate attribute set; and determining, in response to the push strategy being pushing the attribute querying information, a piece of attribute information with a highest recommendation score in the candidate attribute set as the current to-be-pushed object; or determining, in response to the push strategy being pushing the product information, a piece of product information with a highest recommendation score in the candidate product set as the current to-be-pushed object.

In some embodiments, the method further includes: deleting, in response to determining that feedback information of the user for the attribute querying information represents a rejection, an attribute in the attribute querying information from the candidate attribute set.

In some embodiments, the method further includes: deleting, in response to determining that feedback information of the user for the pushed product information represents a rejection, the product information from the candidate product set.

In some embodiments, the extracting preference attributes of a user for a product from user dialogue information in a current dialogue scenario includes: opening, in response to receiving an instruction requesting to open a dialogue scenario, the current dialogue scenario, and acquiring the user dialogue information in the current dialogue scenario in real time; and determining, in response to receiving information representing that the user actively confirms a product attribute, the product attribute in the information as a preference attribute; and determining, in response to determining that feedback information of the user for the attribute querying information represents an acceptance, an attribute in the attribute querying information as a preference attribute.

In some embodiments, the dialogue path is generated by: determining, in response to receiving information that the user confirms a product attribute for a first time, the product attribute indicated by the information as an initial preference attribute; determining an attribute node corresponding to the initial preference attribute in the knowledge graph as an initial node of the dialogue path; and sorting the attribute nodes according to the dialogue time sequence by using the initial node as a start point to generate the dialogue path.

In some embodiments, the current state vector is generated by: extracting feedback information of the user for each piece of pushed attribute querying information from the dialogue record, and coding a result of each piece of feedback information according to a preset strategy; sorting coded results of pieces of feedback information according to the dialogue time sequence to obtain a first sub-vector; determining the number of pieces of the product information in a candidate product sub-set corresponding to each effective attribute node in the dialogue path, and sorting the number of pieces of the product information in each candidate product sub-set according to the dialogue time sequence to obtain a second sub-vector; and splicing the first sub-vector and the second sub-vector to obtain the current state vector.

Embodiments of the present disclosure provide an apparatus for pushing information, and the apparatus includes: a preference extraction unit, configured to extract preference attributes of a user for a product from user dialogue information in a current dialogue scenario; an attribute mapping unit, configured to determine an effective attribute node corresponding to each preference attribute in a pre-constructed knowledge graph, where the knowledge graph includes attribute nodes, product nodes and edges each connecting an attribute node and a product node, and each edge represents an association relationship between a product node and an attribute node connected by the edge; a path generation unit, configured to sort the effective attribute nodes according to a dialogue time sequence to generate a dialogue path; a path parsing unit, configured to determine a candidate attribute set and a candidate product set based on the dialogue path, where the candidate attribute set comprises only each adjacent attribute of an effective attribute node at an end of the dialogue path in the knowledge graph, and the candidate product set comprises product information represented by each product node connected to the each effective attribute node; a strategy prediction unit, configured to predict a current push strategy based on a current state vector by using a pre-trained strategy prediction model, where the current state vector is generated based on a dialogue record in the current dialogue scenario, and the push strategy represents pushing attribute querying information or pushing product information to the user at a current time; an information generation unit configured to determine a to-be-pushed object from the candidate attribute set or the candidate product set based on the current push strategy, and generate current to-be-pushed information based on the to-be-pushed object; and an information push unit configured to push the current to-be-pushed information.

In some embodiments, the information generation unit includes an object determination module configured to determine a recommendation score of each piece of product information in the candidate product set based on a user embedding vector, an embedding vector of each piece of product information in the candidate product set, and an embedding vector of attribute information represented by each effective attribute node, where the user embedding vector is generated based on a user portrait; determine a recommendation score of each piece of attribute information in the candidate attribute set based on the recommendation score of each piece of product information in the candidate product set and an embedding vector of each piece of attribute information in the candidate attribute set; and determine, in response to the push strategy being pushing the attribute querying information, a piece of attribute information with a highest recommendation score in the candidate attribute set as the current to-be-pushed object; or determine, in response to the push strategy being pushing the product information, a piece of product information with a highest recommendation score in the candidate product set as the current to-be-pushed object.

In some embodiments, the apparatus further includes a candidate attribute update unit configured to delete, in response to determining that feedback information of the user for the attribute querying information represents a rejection, an attribute in the attribute querying information from the candidate attribute set.

In some embodiments, the apparatus further includes a candidate product update unit configured to delete, in response to determining that feedback information of the user for the pushed product information represents a rejection, the product information from the candidate product set.

In some embodiments, the preference extraction unit further includes: an information acquisition module, configured to open, in response to receiving an instruction requesting to open a dialogue scenario, the current dialogue scenario, and acquire the user dialogue information in the current dialogue scenario in real time; and an attribute determination module, configured to determine, in response to receiving information representing that the user actively confirms a product attribute, the product attribute in the information as a preference attribute; and determine, in response to determining that feedback information of the user for the attribute querying information represents an acceptance, an attribute in the attribute querying information as a preference attribute.

In some embodiments, the path generation unit further includes: an initial attribute determination module, configured to determine, in response to receiving information that the user confirms a product attribute for a first time, the product attribute indicated by the information as an initial preference attribute; an initial node determination module configured to determine an attribute node corresponding to the initial preference attribute in the knowledge graph as an initial node of the dialogue path; and a path generation module, configured to sort the attribute nodes according to the dialogue time sequence by using the initial node as a start point to generate the dialogue path.

In some embodiments, the apparatus further includes a state vector generation unit configured to extract feedback information of the user for each piece of pushed attribute querying information from the dialogue record, and coding a result of each piece of feedback information according to a preset strategy; sort coded results of pieces of feedback information according to the dialogue time sequence to obtain a first sub-vector; determine the number of pieces of the product information in a candidate product sub-set corresponding to each effective attribute node in the dialogue path, and sort the number of pieces of the product information in each candidate product sub-set according to the dialogue time sequence to obtain a second sub-vector; and splice the first sub-vector and the second sub-vector to obtain the current state vector.

Embodiments of the present disclosure provide an electronic device, and the electronic device includes: one or more processors; and a storage apparatus configured to store one or more programs, where the one or more programs, when executed by the one or more processors, cause the one or more processors to implement the method in any embodiments described above.

Embodiments of the present disclosure provide a non-transitory computer readable medium storing a computer program, where the program, when executed by a processor, implements the method in any embodiments described above.

### BRIEF DESCRIPTION OF THE DRAWINGS

Through detailed descriptions of non-limiting embodiments given with reference to the following accompanying drawings, other features, objectives and advantages of the present disclosure will be more apparent:

FIG. 1 is a diagram of an exemplary system architecture in which some embodiments of the present disclosure may be applied;

FIG. 2 is a flowchart of an embodiment of a method for pushing information according to the present disclosure;

FIG. 3 is a schematic diagram of a scenario of the method for pushing information shown in FIG. 2;

FIG. 4 is a flowchart of a method for determining a to-be-pushed object in an embodiment of the method for pushing information according to the present disclosure;

FIG. 5 is a schematic structural diagram of an embodiment of an apparatus for pushing information according to the present disclosure; and

FIG. 6 is a schematic structural diagram of an electronic device adapted to implement embodiments of the present disclosure.

### DETAILED DESCRIPTION OF EMBODIMENTS

The present disclosure is further described below in detail by combining the accompanying drawings and the embodiments. It may be appreciated that the specific embodiments described herein are merely used for explaining the relevant disclosure, rather than limiting the disclosure. In addition, it should also be noted that, for the ease of description, only the parts related to the relevant disclosure are shown in the accompanying drawings.

It should be noted that the embodiments in the present disclosure and the features in the embodiments may be combined with each other on a non-conflict basis. The present disclosure will be described below in detail with reference to the accompanying drawings and in combination with the embodiments.

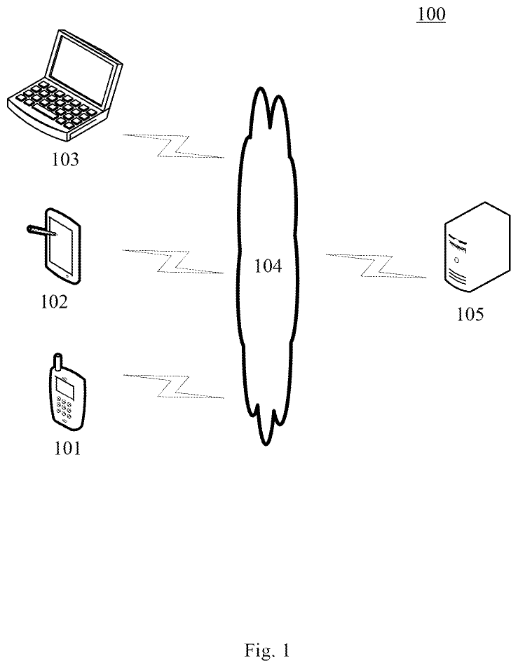

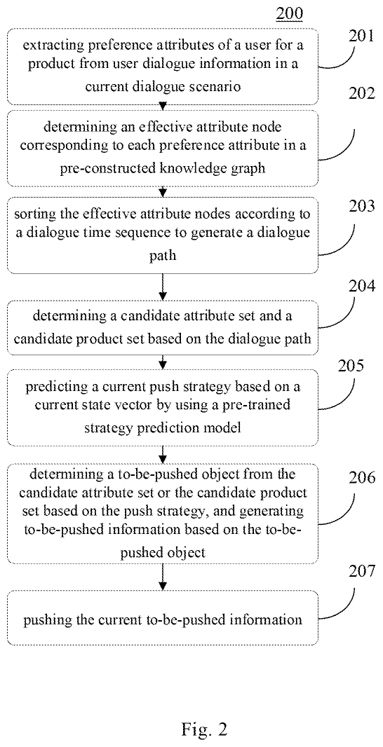

FIG. 1 illustrates an exemplary system architecture 100 in which a method for pushing information or an apparatus for pushing information according to embodiments of the present disclosure may be applied.

As shown in FIG. 1, the system architecture 100 may include terminal devices 101, 102 and 103, a network 104 and a server 105. The network 104 serves as a medium providing a communication link between the terminal devices 101, 102 and 103 and the server 105. The network 104 may include various types of connections, such as wired or wireless communication links, or fiber optic cables.

The user may use the terminal devices 101, 102 and 103 to interact with the server 105 via the network 104, to receive or send a message, etc. For example, the terminal devices may transmit the preference information of the user for a product to the server, and alternatively may receive the pushed information from the server, such as, attribute querying information or product information.

The terminal devices 101, 102 and 103 may be hardware or software. When being the hardware, the terminal devices 101, 102 and 103 may be electronic devices having communication functions, including but not limit to a smartphone, a tablet computer, an electronic book reader, a laptop computer, a desktop computer, and the like. When being the software, the terminal devices 101, 102 and 103 may be installed on the above-listed electronic devices. The terminal devices 101, 102 and 103 may be implemented as a plurality of pieces of software or a plurality of software modules for providing a distributed service, or may be implemented as a single piece of software or a single software module. For example, the terminal devices may be a client of an electronic commerce platform through which the user can interact with the server 105. It is not specifically limited in the present disclosure.

The server 105 may be a server providing various services, such as, a background data server that processes user dialogue information data uploaded by the terminal devices 101, 102 and 103 (e.g., determines a preference attribute of the user from the user dialogue information data). The background data server may perform processing such as analyzing and identifying the received user dialogue information data, and feed back a processing result (e.g., generated push information) to the terminal devices.

It should be noted that the method for pushing information provided by the embodiments of the present disclosure may be performed by the server 105. Accordingly, the apparatus for pushing information may be provided in the server 105.

It should be noted that the server may be hardware or software. When being the hardware, the server may be implemented as a distributed server cluster composed of a plurality of servers, or as a single server. When being the software, the server may be implemented as a plurality of pieces of software or a plurality of software modules for providing a distributed service, or may be implemented as a single piece of software or a single software module, which will not be specifically limited here.

Further referring to FIG. 2, FIG. 2 illustrates a flow 200 of an embodiment of a method for pushing information according to the present disclosure. The method for pushing information includes the following steps.

Step 201, extracting preference attributes of a user for a product from user dialogue information in a current dialogue scenario.

In this embodiment, a preference attribute of the user for the product represents a desired parameter of the user for the product. After the execution body (for example, the server shown in FIG. 1) receives the dialogue information sent by the user, the execution body may extract the preference attributes of the user for the product from the user dialogue information by using a semantic analysis or keyword extraction algorithm.

In a specific application scenario, the user may perform information interaction with the execution body (a cloud of the electronic commerce platform) through a client of the electronic commerce platform loaded in a terminal (such as the smartphone shown in FIG. 1). For example, if the user sends the information “I want to buy a basketball kit” to the execution body through the terminal, the execution body may determine that the preference attribute of the user is “basketball” from the information.

In some further implementations of this embodiment, the extracting preference attributes of a user for a product from user dialogue information in a current dialogue scenario includes: opening, in response to receiving an instruction requesting to open a dialogue scenario, the current dialogue scenario, and acquiring the user dialogue information in the current dialogue scenario in real time; and determining, in response to receiving information representing that the user actively confirms a product attribute, the product attribute in the information as a preference attribute; and determining, in response to determining that feedback information of the user for the attribute querying information represents an acceptance, an attribute in the attribute querying information as a preference attribute.

In these implementations, when the execution body receives the instruction (which may be, for example, information sent by the user for the first time) indicating that the user requests to open the dialogue scenario, the execution body acquires the user dialogue information in real time so as to extract the preference attribute of the user for the product.

Generally, a plurality of rounds of dialogues are included in a dialogue scenario, and the user dialogue information includes the information that the user actively confirms a product attribute, and the feedback information provided by the user for pushed information in each round of dialogue. In a round of dialogue, the execution body pushes information to the user once, and receives feedback information from the user for the information. For example, at a certain time, the execution body pushes the information “Do you like white” to the user, and reply information of the user for this information is the feedback information. For example, if the user replies “Yes”, which indicates that the feedback information of the user for this information represents an acceptance, then “white” may be determined as the preference attribute of the user; and if the user replies “no”, which indicates that the feedback information of the user for this information represents a rejection, then “white” should not be used as the preference attribute of the user.

Step 202, determining an effective attribute node corresponding to each preference attribute in a pre-constructed knowledge graph.

In this embodiment, the knowledge graph includes attribute nodes, product nodes and edges each connecting an attribute node and a product node, where each edge represents an association relationship between a product node and an attribute node connected by the edge. The knowledge graph is used to represent associations relationships between products and attributes, and may be pre-constructed based on original data provided by a business party and stored in the execution body. As an example, the execution body may accept the original data provided by the business party, then extract the product information, the attribute information, and the association relationship between the product information and the attribute information from the original data, then use the product information as the product node, use the attribute information as the attribute node, and finally use the edge to connect the node corresponding to the product information and the node corresponding to the attribute information, where the product information and the attribute information have the association relationship.

In this embodiment, the effective attribute node represents an attribute node corresponding to a preference attribute confirmed by the user in the knowledge graph, which may be, for example, a preference attribute actively confirmed by the user, or a preference attribute accepted by the user during the dialogue process performed by the execution body.

Step 203, sorting the effective attribute nodes according to a dialogue time sequence to generate a dialogue path.

In this embodiment, each effective attribute node in the dialogue path is a preference attribute confirmed by the user in the current dialogue scenario according to the dialogue time sequence, that is, corresponding to a process in which the execution body gradually acquires a desired parameter of the user for the product. As the number of dialogue rounds increases, the execution body may continuously acquire new preference attributes from the user information through steps 202 and 203, thereby continuously updating the dialogue path.

It can be understood that when the execution body acquires sufficient preference attributes, the execution body may determine the desired product of the user based on the preference attributes.

In some further implementations of this embodiment, the dialogue path is generated by: determining, in response to receiving information that the user confirms a product attribute for a first time, the product attribute indicated by the information as an initial preference attribute; determining an attribute node corresponding to the initial preference attribute in the knowledge graph as an initial node of the dialogue path; and sorting the attribute nodes according to the dialogue time sequence by using the initial node as a start point to generate the dialogue path.

Step 204, determining a candidate attribute set and a candidate product set based on the dialogue path.

In this embodiment, the candidate attribute set includes only each adjacent attribute of an effective attribute node at an end of the dialogue path in the knowledge graph, and a candidate product set includes product information represented by each product node connected to each effective attribute node. The effective attribute node at the end of the dialogue path represents a latest preference attribute of the user for the product determined by the execution body.

If there is only one product node between two attribute nodes, pieces of attribute information represented by the two attribute nodes represent two adjacent attributes.

As an example, the knowledge graph includes attribute nodes A, B, C, and D. A is connected with product nodes A1, A2, and A3, B is connected with product nodes B1 and B2, C is connected with product nodes A3 and B1, and D is connected with product nodes A1 and B2. If the dialogue path obtained by the execution body based on step 203 is A-C-D, the product nodes connected to node D are A1 and B2, and the attribute nodes directly connected to A1 and B2 are A and B, the execution body may determine that the candidate attribute set at the current time includes attribute information represented by node A and node B, where there are product nodes A1 and A3 between node D and node C, and therefore the attribute represented by node C is not an adjacent attribute of node D. The candidate product set includes a set of product information represented by product nodes connected to nodes A, C, D, respectively, and specifically includes products A1, A2, A3, B1, and B2.

Step 205, predicting a current push strategy based on a current state vector by using a pre-trained strategy prediction model.

In this embodiment, the current state vector is generated based on a dialogue record in the current dialogue scenario, and the push strategy represents pushing attribute querying information or product information. The strategy prediction model represents a corresponding relationship between a current state vector and a push strategy. The current state vector may represent all information related to the push strategy at the current time, and may include, for example, an entire dialogue record, attribute information in the candidate attribute set, product information in the candidate product set, and the like.

As an example, a reinforcement learning model may be used as the strategy prediction model to predict an action (a push strategy) at a current moment based on a state of a previous time. Then the execution body pushes information to the user based on the predicted push strategy, and receives feedback information of the user. Next, the execution body updates a state of the reinforcement learning model based on the feedback information of the user, and the reinforcement learning model predicts an action (a push strategy) at a next time based on the updated state. In this way, the push strategy in each round of the dialogue may be determined based on the user dialogue information.

In the related technologies, a reinforcement learning model is used to directly predict a to-be-pushed object, and the number of action categories of the reinforcement learning model at a decision stage is greater than a sum of the number of candidate products and the number of candidate attributes. The strategy prediction model in this embodiment can reduce the number of the action categories to two (pushing attribute querying information and pushing product information). Thus, a convergence speed of the model can be improved, and a training efficiency can be greatly improved.

In some alternative implementations of this embodiment, the current state vector is generated by: extracting feedback information of the user for each piece of pushed attribute querying information from the dialogue record, and coding a result of each piece of feedback information according to a preset strategy; sorting coded results of the feedback information according to the dialogue time sequence to obtain a first sub-vector; determining the number of pieces of the product information in a candidate product sub-set corresponding to each effective attribute node in the dialogue path, and sorting the number of pieces of the product information in each candidate product sub-set according to the dialogue time sequence to obtain a second sub-vector; and splicing the first sub-vector and the second sub-vector to obtain the current state vector.

In this implementation, the first sub-vector represents a feedback result of the user for the pushed attribute information. For example, a code of attribute information accepted by the user may be set as 1, a code of attribute information rejected by the user may be set as 0, and the codes may be sorted according to the time sequence information of the attribute information, so that the first sub-vector composed of 1s (ones) and 0s (zeros) may be obtained. In this way, the execution body may determine the push strategy at the current time according to the first sub-vector. For example, if there are fewer is in the first sub-vector, the execution body should continue to push the attribute querying information to the user; and if there are more is in the first sub-vector, the execution body may push the product information to the user.

As an example, the dialogue path includes the attribute nodes of A-C-D, where the number of pieces of the product information in the candidate product sub-set corresponding to node A is 3, the number of pieces of the product information in the candidate product sub-set corresponding to node C is 2, and the number of pieces of the product information in the candidate product sub-set corresponding to node D is 5, and then the second sub-vector obtained by the execution body is (3, 2, 5). Thus, a probability of the pushed product information being accepted by the user can be estimated based on the number of candidate products.

In this implementation, the current state vector is obtained by concatenating the first sub-vector and the second sub-vector, which helps to improve an accuracy of the strategy prediction model in predicting a push strategy.

Step 206, determining a to-be-pushed object from the candidate attribute set or the candidate product set based on the push strategy, and generating to-be-pushed information based on the to-be-pushed object.

In this embodiment, the execution body may determine whether to query the user for an attribute or to push product information according to the push strategy predicted in step 205.

As an example, if the push strategy is to push the attribute querying information, the execution body may randomly determine one piece of attribute information from the candidate attribute set as the to-be-pushed object. If the push strategy is to push the product information, the execution body may randomly determine one piece of product information from the candidate product set as the to-be-pushed object. Then, the to-be-pushed object is used as a keyword, and a preset text generation algorithm is used to generate the to-be-pushed information.

Step 207, pushing the current to-be-pushed information.

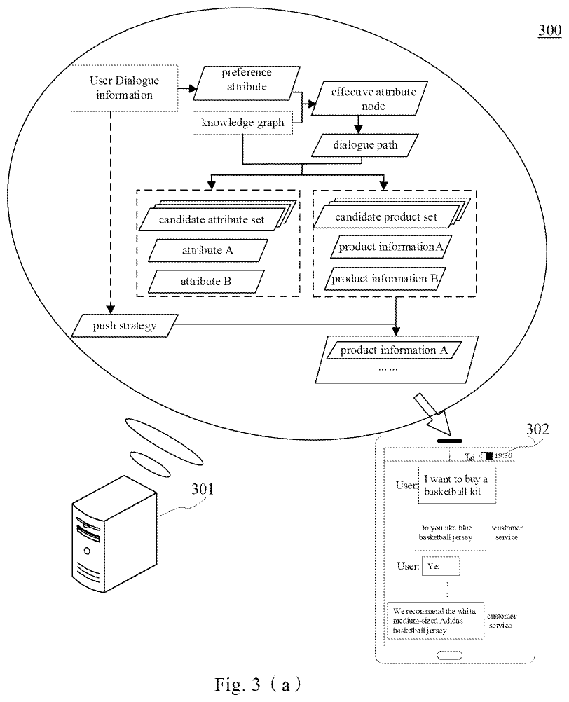

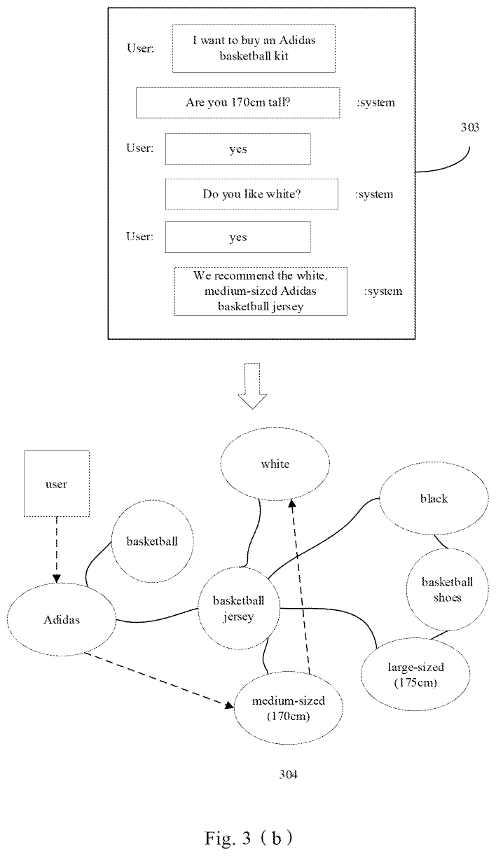

Further referring to FIG. 3, FIG. 3 is a schematic diagram of a scenario of a method for pushing information as shown in FIG. 2. In the interaction scenario shown in FIG. 3 (a), the execution body 301 may be a cloud server of the electronic commerce platform. The terminal device 302 may be a smartphone of a user, and the user may perform information interaction with the execution body through a client of the electronic commerce platform loaded on the smartphone. For example, the user may send information “I want to buy a basketball kit”, the feedback information “Yes” for the pushed information, and the like to the execution body. The execution body extracts preference attributes of the user for a product from the received user information, such as “basketball” and “white”. FIG. 3 (b) shows a schematic diagram of mapping preferences of the user to attribute nodes in a knowledge graph and generating a dialogue path. The execution body successively extracts preference attributes “Adidas”, “170 cm”, and “white” from the dialogue 304 between the user and the execution body.

These preference attributes are then mapped to the knowledge graph to obtain effective attribute nodes “Adidas”, “medium size”, and “white”. Based on these nodes, the execution body generates a dialogue path consisting of “Adidas”—“medium size”—“white”. Based on this dialogue path, the execution body determines a candidate attribute set (including attribute A and attribute B) and a candidate product set (including product information A and product information B), and then uses a strategy prediction model to predict a current push strategy. For example, if the current push strategy is to push product information, the execution body selects product information A from the candidate product set as a to-be-pushed object and generates to-be-pushed information “We recommend the white, medium-sized Adidas basketball jersey”. Finally, the execution body sends this information to the smartphone of the user.

According to the method and apparatus for pushing information provided in the embodiments of the present disclosure, preference attributes of a user are extracted from user dialogue information, the preference attribute of the user is mapped to an attribute node in a knowledge graph, a dialogue path is generated based on a dialogue time sequence and each attribute node, and each adjacent attribute of an attribute node at the end of the dialogue path is determined as a candidate attribute, which can not only improve the coherence among information pushed to the user but also effectively reduce the dimensionality of the candidate attribute space. Thus, the pertinence and efficiency of the pushed information can be improved, and the number of action categories of a strategy prediction model can be reduced to two, so that a training efficiency of the strategy prediction model can be effectively improved.

In some alternative implementations of this embodiment, the method may further include: deleting, in response to determining that feedback information of the user for the attribute querying information represents a rejection, an attribute in the attribute querying information from the candidate attribute set.

It can be understood that different attribute nodes may have the same adjacent attribute, and if a certain adjacent attribute has been rejected by the user, the attribute information is deleted from the candidate attribute set. On the one hand, the attribute information can be prevented from being pushed again, and on the other hand, the number of pieces of candidate attribute information can be reduced, thereby further reducing a computation amount.

In some alternative implementations of this embodiment, the method may further include: in response to determining that feedback information of the user for the pushed product information represents a rejection, the product information from the candidate product set. In this way, the number of pieces of candidate product information can be reduced, thereby further reducing the computation amount.

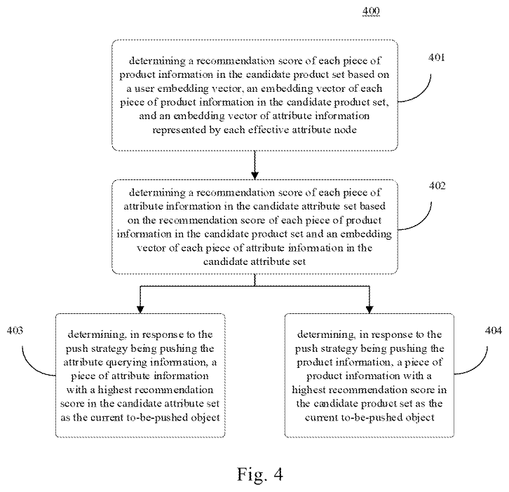

Further referring to FIG. 4, FIG. 4 shows a flow 400 of a method for determining a to-be-pushed object in an embodiment of the method for pushing information. The flow 400 includes the following steps.

Step 401, determining a recommendation score of each piece of product information in the candidate product set based on a user embedding vector, an embedding vector of each piece of product information in the candidate product set, and an embedding vector of attribute information represented by each effective attribute node.

In this embodiment, the user embedding vector is generated based on a user portrait to represent characteristic information of the user, and may include information such as height, weight, occupation, interest, and the like of the user.

As an example, the execution body may determine the recommendation score of each piece of product information in the candidate product set by using the following equations (1) and (2).

sᵥ=f(v,u,pᵤ) (1)

f(v,u,pᵤ)=u^{T}v+Σ_{p∈p}_{ᵤ}v^{T}p (2)

Here, sᵥ denotes a recommendation score of a candidate product v, and pᵤ denotes an effective attribute node; U denotes an embedding vector of a user, v denotes an embedding vector of the candidate product v, and p denotes an embedding vector of attribute information p.

Step 402, determining a recommendation score of each piece of attribute information in the candidate attribute set based on the recommendation score of each piece of product information in the candidate product set and an embedding vector of each piece of attribute information in the candidate attribute set.

In this embodiment, the execution body may determine the recommendation score of each piece of attribute information in the candidate attribute set based on the embedding vector of each piece of attribute information in the candidate attribute set and the recommendation score of each piece of product information in the candidate product set obtained in step 401. As an example, the execution body may obtain the recommendation score of each piece of attribute information in the candidate attribute set by using equations (3), (4), and (5).

$${s}_{p} = g ( u , p , {V}_{cand} ) \qquad ( 3 )$$

$$g ( u , p , {V}_{cand} ) = - prob ( p ) \times {log}_{2} ( prob ( p ) ) \qquad ( 4 )$$

$$prob ( p ) = \frac{{\sum }_{v ∈ {V}_{cand} ⋂ {V}_{p}} σ ( {s}_{v} )}{{\sum }_{v ∈ {V}_{cand}} σ ( {s}_{v} )} \qquad ( 5 )$$

Here, σ denotes a Sigmoid function that normalizes the recommendation score Sv of product information to a value between 0 and 1, Vcand denotes a candidate attribute set, and Vp denotes product information including attribute information p.

Step 403, determining, in response to the push strategy being pushing the attribute querying information, a piece of attribute information with a highest recommendation score in the candidate attribute set as the current to-be-pushed object.

Step 404, determining, in response to the push strategy being pushing the product information, a piece of product information with a highest recommendation score in the candidate product set as the current to-be-pushed object.

In some alternative implementations of this embodiment, the execution body may use the preset number of pieces of product information with the highest recommendation scores in the candidate product set as the current to-be-pushed object, and then may push a plurality of pieces of product information to the user at one time, or may push each piece of product information in descending order of their recommendation scores.

As can be seen from FIG. 4, the flow 400 for determining a to-be-pushed object in this embodiment highlights the steps of determining the recommendation scores of each candidate product information and each candidate attribute information based on the product information in the candidate product set and the attribute information in the candidate attribute set, and determining the current to-be-pushed object based on the recommendation scores. Since the recommendation score of the product information and the recommendation score of the attribute information are interdependent, the pertinence of the to-be-pushed object is improved, thereby improving the accuracy of pushing information.

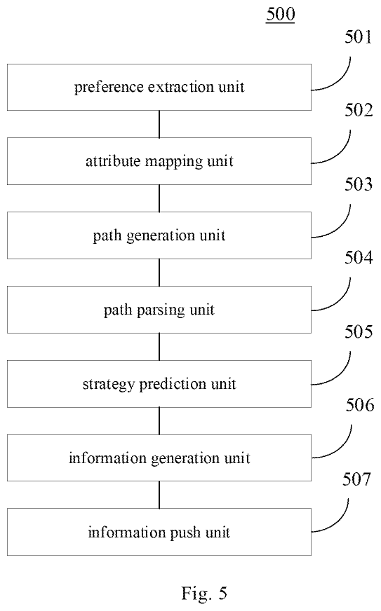

Further referring to FIG. 5, as an implementation of the method shown in the above drawings, the present disclosure provides an embodiment of an apparatus for pushing information. The embodiment of the apparatus corresponds to the embodiment of the method shown in FIG. 2. The apparatus may be applied in various electronic devices.

As shown in FIG. 5, an apparatus 700 for pushing information of this embodiment includes: a preference extraction unit 501 configured to extract preference attributes of a user for a product from user dialogue information in a current dialogue scenario; an attribute mapping unit 502 configured to determine an effective attribute node corresponding to each preference attribute in a pre-constructed knowledge graph, wherein the knowledge graph comprises attribute nodes, product nodes and edges each connecting an attribute node and a product node, and each edge represents an association relationship between a product node and an attribute node connected by the edge; a path generation unit 503 configured to sort the effective attribute nodes according to a dialogue time sequence to generate a dialogue path; a path parsing unit 504 configured to determine a candidate attribute set and a candidate product set based on the dialogue path, wherein the candidate attribute set comprises only each adjacent attribute of an effective attribute node at an end of the dialogue path in the knowledge graph, and the candidate product set comprises product information represented by each product node connected to the each effective attribute node; a strategy prediction unit 505 configured to predict a current push strategy based on a current state vector by using a pre-trained strategy prediction model, wherein the current state vector is generated based on a dialogue record in the current dialogue scenario, and the push strategy represents pushing attribute querying information or pushing product information to the user at a current time; an information generation unit 506 configured to determine a to-be-pushed object from the candidate attribute set or the candidate product set based on the current push strategy, and generate current to-be-pushed information based on the to-be-pushed object; and an information push unit 507 configured to push the current to-be-pushed information.

In this embodiment, the information generation unit 506 includes an object determination module configured to determine a recommendation score of each piece of product information in the candidate product set based on a user embedding vector, an embedding vector of each piece of product information in the candidate product set, and an embedding vector of attribute information represented by each effective attribute node, where the user embedding vector is generated based on a user portrait; determine a recommendation score of each piece of attribute information in the candidate attribute set based on the recommendation score of each piece of product information in the candidate product set and an embedding vector of each piece of attribute information in the candidate attribute set; and determine, in response to the push strategy being pushing the attribute querying information, a piece of attribute information with a highest recommendation score in the candidate attribute set as the current to-be-pushed object; or determine, in response to the push strategy being pushing the product information, a piece of product information with a highest recommendation score in the candidate product set as the current to-be-pushed object.

In this embodiment, the apparatus 500 further includes a candidate attribute update unit configured to delete, in response to determining that feedback information of the user for the attribute querying information represents a rejection, an attribute in the attribute querying information from the candidate attribute set.

In this embodiment, the apparatus further includes a candidate product update unit configured to delete, in response to determining that feedback information of the user for the pushed product information represents a rejection, the product information from the candidate product set.

In this embodiment, the preference extraction unit further 501 includes: an information acquisition module, configured to open, in response to receiving an instruction requesting to open a dialogue scenario, the current dialogue scenario, and acquire the user dialogue information in the current dialogue scenario in real time; and an attribute determination module, configured to determine, in response to receiving information representing that the user actively confirms a product attribute, the product attribute in the information as a preference attribute; and determine, in response to determining that feedback information of the user for the attribute querying information represents an acceptance, an attribute in the attribute querying information as a preference attribute.

In this embodiment, the path generation unit 503 further includes: an initial attribute determination module, configured to determine, in response to receiving information that the user confirms a product attribute for a first time, the product attribute indicated by the information as an initial preference attribute; an initial node determination module, configured to determine an attribute node corresponding to the initial preference attribute in the knowledge graph as an initial node of the dialogue path; and a path generation module, configured to sort the attribute nodes according to the dialogue time sequence by using the initial node as a start point to generate the dialogue path.

In this embodiment, the apparatus 500 further includes a state vector generation unit configured to extract feedback information of the user for each piece of pushed attribute querying information from the dialogue record, and coding a result of each piece of feedback information according to a preset strategy; sort coded results of pieces of feedback information according to the dialogue time sequence to obtain a first sub-vector; determine the number of pieces of the product information in a candidate product sub-set corresponding to each effective attribute node in the dialogue path, and sort the number of pieces of the product information in each candidate product sub-set according to the dialogue time sequence to obtain a second sub-vector; and splice the first sub-vector and the second sub-vector to obtain the current state vector.

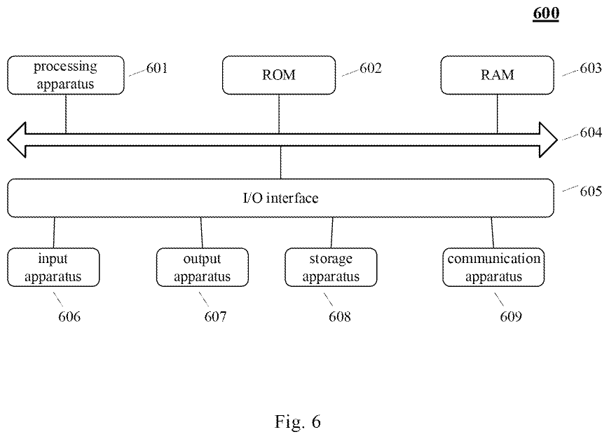

Further referring to FIG. 6, FIG. 6 is a schematic structural diagram of an electronic device 600 (for example, the server or terminal devices shown in FIG. 1) adapted to implement the embodiments of the present disclosure. The terminal devices in the embodiments of the present disclosure may include, but are not limited to, mobile terminals such as a mobile phone, a notebook computer, a digital broadcast receiver, a PDA (Personal Digital Assistant), a PAD (Tablet Computer), and the like, and fixed terminals such as a digital TV, a desktop computer, and the like. The terminal device shown in FIG. 6 is merely an example and should not be construed as limiting the functionality and scope of use of the embodiments of the present disclosure.

As shown in FIG. 6, the electronic device 600 may include a processing apparatus 601 (e.g., a central processing unit or a graphics processing unit), which may execute various appropriate actions and processes in accordance with a program stored in a read only memory (ROM) 602 or a program loaded into a random-access memory (RAM) 603 from a storage apparatus 608. The RAM 603 further stores various programs and data required by operations of the electronic device 600. The CPU 601, the ROM 602, and the RAM 603 are connected to each other through a bus 604. An input/output (I/O) interface 605 is also connected to the bus 604.

In general, the following apparatuses may be connected to the I/O interface 605: an input apparatus 606 including a touch screen, a touch pad, a keyboard, a mouse, a camera, a microphone, an accelerometer, a gyroscope, or the like; an output apparatus 607 including a liquid crystal display device (LCD), a speaker, a vibrator, or the like; a storage apparatus 608 including a magnetic tape, a hard disk, or the like; and a communication apparatus 609. The communication apparatus 609 may allow the electronic device 600 to exchange data with other devices through wireless or wired communication. While FIG. 6 shows the electronic device 600 having various apparatuses, it should be understood that it is not necessary to implement or provide all of the apparatuses shown in the figure. More or fewer apparatuses may be alternatively implemented or provided. Each block shown in FIG. 6 may represent an apparatus, or represent a plurality of apparatuses as required.

In particular, according to the embodiments of the present disclosure, the process described above with reference to the flow chart may be implemented as a computer software program. For example, the embodiments of the present disclosure include a computer program product, which includes a computer program that is tangibly embedded in a computer readable medium. The computer program includes a program code for executing the method as shown in the flow chart. In such an embodiment, the computer program may be downloaded and installed from a network via the communication apparatus 609, or be installed from the storage apparatus 608, or be installed from the ROM 602. The computer program, when executed by the processing apparatus 601, implements the above functions as defined by the method of the embodiments of the present disclosure. It should be noted that the computer readable medium of the embodiments of the present disclosure may be a computer readable signal medium or a computer readable storage medium, or any combination of the above two. An example of the computer readable storage medium may include, but is not limited to: electric, magnetic, optical, electromagnetic, infrared, or semiconductor systems, apparatuses, elements, or a combination of any of the above. A more specific example of the computer readable storage medium may include, but is not limited to: an electrical connection with one or more pieces of wire, a portable computer disk, a hard disk, a random-access memory (RAM), a read only memory (ROM), an erasable programmable read-only memory (EPROM or flash memory), an optical fiber, a portable compact disk read-only memory (CD-ROM), an optical memory, a magnetic memory, or any suitable combination of the above. In the embodiments of the present disclosure, the computer readable storage medium may be any tangible medium containing or storing programs which may be used by, or used in combination with, a command execution system, apparatus or element. In the embodiments of the present disclosure, the computer readable signal medium may include a data signal in the base band or propagating as a part of a carrier wave, in which a computer readable program code is carried. The propagating data signal may take various forms, including but not limited to an electromagnetic signal, an optical signal, or any suitable combination of the above. The computer readable signal medium may also be any computer readable medium except for the computer readable storage medium. The computer readable signal medium is capable of transmitting, propagating or transferring programs for use by, or use in combination with, a command execution system, apparatus or element. The program code contained on the computer readable medium may be transmitted with any suitable medium, including but not limited to: wire, an optical cable, a RF (radio frequency) medium etc., or any suitable combination of the above.

The above computer readable medium may be the computer readable medium included in the above electronic device, or a stand-alone computer readable medium not assembled into the electronic device. The above computer readable medium carries one or more programs. The one or more programs, when executed by the electronic device, cause the electronic device to: extract a preference attribute of a user for a product from user dialogue information in a current dialogue scenario; determine an effective attribute node corresponding to the preference attribute in a pre-constructed knowledge graph, where the knowledge graph includes an attribute node, a product node and an edge connecting the attribute node and the product node, where the edge represents an association relationship between the product node and the attribute node; arrange each effective attribute node according to a dialogue time sequence to generate a dialogue path; determine a candidate attribute set and a candidate product set based on the dialogue path, where the candidate attribute set includes only an adjacent attribute of an effective attribute node at an end of the dialogue path in the knowledge graph, and the candidate product set includes product information represented by a product node connected to each effective attribute node; predict a current push strategy based on a current state vector by using a pre-trained strategy prediction model, where the current state vector is generated based on a dialogue record in the current dialogue scenario, and the push strategy represents pushing an attribute querying information or product information to the user at a current time; determine a to-be-pushed object from the candidate attribute set or the candidate product set based on the push strategy, and generate current to-be-pushed information based on the to-be-pushed object; and push the current to-be-pushed information.

A computer program code for executing operations in the embodiments of the present disclosure may be compiled by using one or more programming languages or combinations thereof. The programming languages include object-oriented programming languages, such as Java, Smalltalk or C++, and also include conventional procedural programming languages, such as “C” language or similar programming languages. The program code may be completely executed on a user's computer, partially executed on a user's computer, executed as a separate software package, partially executed on a user's computer and partially executed on a remote computer, or completely executed on a remote computer or server. In the case where a remote computer is involved, the remote computer may be connected to a user computer through any kind of networks, including a local area network (LAN) or a wide area network (WAN), or may be connected to an external computer (for example, connected through the Internet by using an Internet service provider).

The flow charts and block diagrams in the figures illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion including one or more executable instructions for implementing specified logic functions. It should also be noted that, in some alternative implementations, functions annotated in the blocks may also occur in an order different from the order annotated in the figures. For example, any two blocks presented in succession may be executed substantially in parallel, or sometimes be executed in a reverse sequence, depending on the functions involved. It should also be noted that each block in the block diagrams and/or flow charts as well as a combination of blocks in the block diagrams and/or flow charts may be implemented by using a dedicated hardware-based system executing specified functions or operations, or by a combination of dedicated hardware and computer instructions.

The described units involved in the embodiments of the present disclosure may be implemented by means of software or hardware. The described unit can alternatively be provided in a processor, which, for example, can be described as: a processor including a preference extraction unit, an attribute mapping unit, a path generation unit, a path parsing unit, a strategy prediction unit, an information generation unit, and an information push unit. Here, the names of these units do not in some cases constitute a limitation to such units themselves. For example, the preference extraction unit may alternatively be described as “a unit configured to extract a preference attribute of a user for a product from user dialogue information in a current dialogue scenario.”

The above description only provides explanation of the preferred embodiments and the employed technical principles of the present disclosure. It should be appreciated by those skilled in the art that the inventive scope involved in embodiments of the present disclosure is not limited to the technical solutions formed by the particular combinations of the above technical features. The inventive scope should also cover other technical solutions formed by any combination of the above technical features or equivalent features thereof without departing from the inventive concept of the present disclosure, for example, the technical solutions formed by interchanging the above features with, but not limited to, technical features with similar functions disclosed in the embodiments of the present disclosure.

1.-16. (canceled)

17. A method for pushing information, comprising:
extracting preference attributes of a user for a product from user dialogue information in a current dialogue scenario;
determining an effective attribute node corresponding to each preference attribute in a pre-constructed knowledge graph, wherein the knowledge graph comprises attribute nodes, product nodes and edges each connecting an attribute node and a product node, and each edge represents an association relationship between a product node and an attribute node connected by the edge;
sorting the effective attribute nodes according to a dialogue time sequence to generate a dialogue path;
determining a candidate attribute set and a candidate product set based on the dialogue path, wherein the candidate attribute set comprises only each adjacent attribute of an effective attribute node at an end of the dialogue path in the knowledge graph, and the candidate product set comprises product information represented by each product node connected to the each effective attribute node;
predicting a current push strategy based on a current state vector by using a pre-trained strategy prediction model, wherein the current state vector is generated based on a dialogue record in the current dialogue scenario, and the push strategy represents pushing attribute querying information or pushing product information to the user at a current time;
determining a to-be-pushed object from the candidate attribute set or the candidate product set based on the current push strategy, and generating current to-be-pushed information based on the to-be-pushed object; and
pushing the current to-be-pushed information.

18. The method according to claim 17, wherein the current to-be-pushed object is determined by:
determining a recommendation score of each piece of product information in the candidate product set based on a user embedding vector, an embedding vector of each piece of product information in the candidate product set, and an embedding vector of attribute information represented by each effective attribute node, wherein the user embedding vector is generated based on a user portrait;
determining a recommendation score of each piece of attribute information in the candidate attribute set based on the recommendation score of each piece of product information in the candidate product set and an embedding vector of each piece of attribute information in the candidate attribute set; and
determining, in response to the push strategy being pushing the attribute querying information, a piece of attribute information with a highest recommendation score in the candidate attribute set as the current to-be-pushed object; or
determining, in response to the push strategy being pushing the product information, a piece of product information with a highest recommendation score in the candidate product set as the current to-be-pushed object.

19. The method according to claim 17, wherein the method further comprises:
deleting, in response to determining that feedback information of the user for the attribute querying information represents a rejection, an attribute in the attribute querying information from the candidate attribute set.

20. The method according to claim 17, wherein the method further comprises:
deleting, in response to determining that feedback information of the user for the pushed product information represents a rejection, the product information from the candidate product set.

21. The method according to claim 17, wherein the extracting preference attributes of a user for a product from user dialogue information in a current dialogue scenario comprises:
opening, in response to receiving an instruction requesting to open a dialogue scenario, the current dialogue scenario, and acquiring the user dialogue information in the current dialogue scenario in real time; and
determining, in response to receiving information representing that the user actively confirms a product attribute, the product attribute in the information as a preference attribute; and determining, in response to determining that feedback information of the user for the attribute querying information represents an acceptance, an attribute in the attribute querying information as a preference attribute.

22. The method according to claim 17, wherein the dialogue path is generated by:
determining, in response to receiving information that the user confirms a product attribute for a first time, the product attribute indicated by the information as an initial preference attribute;
determining an attribute node corresponding to the initial preference attribute in the knowledge graph as an initial node of the dialogue path; and
sorting the attribute nodes according to the dialogue time sequence by using the initial node as a start point to generate the dialogue path.

23. The method according to claim 17, wherein the current state vector is generated by:
extracting feedback information of the user for each piece of pushed attribute querying information from the dialogue record, and coding a result of each piece of feedback information according to a preset strategy;
sorting coded results of pieces of feedback information according to the dialogue time sequence to obtain a first sub-vector;
determining the number of pieces of the product information in a candidate product sub-set corresponding to each effective attribute node in the dialogue path, and sorting the number of pieces of the product information in each candidate product sub-set according to the dialogue time sequence to obtain a second sub-vector; and
splicing the first sub-vector and the second sub-vector to obtain the current state vector.

24. An apparatus for pushing information, comprising:
at least one processor; and
a memory storing instructions, wherein the instructions when executed by the at least one processor, cause the at least one processor to perform operations, the operations comprising:
extracting preference attributes of a user for a product from user dialogue information in a current dialogue scenario;
determining an effective attribute node corresponding to each preference attribute in a pre-constructed knowledge graph, wherein the knowledge graph comprises attribute nodes, product nodes and edges each connecting an attribute node and a product node, and each edge represents an association relationship between a product node and an attribute node connected by the edge;
sorting the effective attribute nodes according to a dialogue time sequence to generate a dialogue path;
determining a candidate attribute set and a candidate product set based on the dialogue path, wherein the candidate attribute set comprises only each adjacent attribute of an effective attribute node at an end of the dialogue path in the knowledge graph, and the candidate product set comprises product information represented by each product node connected to the each effective attribute node;
predicting a current push strategy based on a current state vector by using a pre-trained strategy prediction model, wherein the current state vector is generated based on a dialogue record in the current dialogue scenario, and the push strategy represents pushing attribute querying information or pushing product information to the user at a current time;
determining a to-be-pushed object from the candidate attribute set or the candidate product set based on the current push strategy, and generating current to-be-pushed information based on the to-be-pushed object; and
pushing the current to-be-pushed information.

25. The apparatus according to claim 24, wherein the current to-be-pushed object is determined by:
determining a recommendation score of each piece of product information in the candidate product set based on a user embedding vector, an embedding vector of each piece of product information in the candidate product set, and an embedding vector of attribute information represented by each effective attribute node, wherein the user embedding vector is generated based on a user portrait;
determining a recommendation score of each piece of attribute information in the candidate attribute set based on the recommendation score of each piece of product information in the candidate product set and an embedding vector of each piece of attribute information in the candidate attribute set; and
determining, in response to the push strategy being pushing the attribute querying information, a piece of attribute information with a highest recommendation score in the candidate attribute set as the current to-be-pushed object; or
determining, in response to the push strategy being pushing the product information, a piece of product information with a highest recommendation score in the candidate product set as the current to-be-pushed object.

26. The apparatus according to claim 24, wherein the operations further comprise:
deleting, in response to determining that feedback information of the user for the attribute querying information represents a rejection, an attribute in the attribute querying information from the candidate attribute set.

27. The apparatus according to claim 24, wherein the operations further comprise:
deleting, in response to determining that feedback information of the user for the pushed product information represents a rejection, the product information from the candidate product set.

28. The apparatus according to claim 24, wherein the extracting preference attributes of a user for a product from user dialogue information in a current dialogue scenario comprises:
opening, in response to receiving an instruction requesting to open a dialogue scenario, the current dialogue scenario, and acquiring the user dialogue information in the current dialogue scenario in real time; and
determining, in response to receiving information representing that the user actively confirms a product attribute, the product attribute in the information as a preference attribute; and determining, in response to determining that feedback information of the user for the attribute querying information represents an acceptance, an attribute in the attribute querying information as a preference attribute.

29. The apparatus according to claim 24, wherein the dialogue path is generated by:
determining, in response to receiving information that the user confirms a product attribute for a first time, the product attribute indicated by the information as an initial preference attribute;
determining an attribute node corresponding to the initial preference attribute in the knowledge graph as an initial node of the dialogue path; and
sorting the attribute nodes according to the dialogue time sequence by using the initial node as a start point to generate the dialogue path.

30. The apparatus according to claim 24, wherein the current state vector is generated by:
extracting feedback information of the user for each piece of pushed attribute querying information from the dialogue record, and coding a result of each piece of feedback information according to a preset strategy;
sorting coded results of pieces of feedback information according to the dialogue time sequence to obtain a first sub-vector;
determining the number of pieces of the product information in a candidate product sub-set corresponding to each effective attribute node in the dialogue path, and sorting the number of pieces of the product information in each candidate product sub-set according to the dialogue time sequence to obtain a second sub-vector; and
splicing the first sub-vector and the second sub-vector to obtain the current state vector.

31. A non-transitory computer readable medium, storing a computer program, wherein the program, when executed by a processor, implements operations comprising:
extracting preference attributes of a user for a product from user dialogue information in a current dialogue scenario;
determining an effective attribute node corresponding to each preference attribute in a pre-constructed knowledge graph, wherein the knowledge graph comprises attribute nodes, product nodes and edges each connecting an attribute node and a product node, and each edge represents an association relationship between a product node and an attribute node connected by the edge;
sorting the effective attribute nodes according to a dialogue time sequence to generate a dialogue path;
determining a candidate attribute set and a candidate product set based on the dialogue path, wherein the candidate attribute set comprises only each adjacent attribute of an effective attribute node at an end of the dialogue path in the knowledge graph, and the candidate product set comprises product information represented by each product node connected to the each effective attribute node;
predicting a current push strategy based on a current state vector by using a pre-trained strategy prediction model, wherein the current state vector is generated based on a dialogue record in the current dialogue scenario, and the push strategy represents pushing attribute querying information or pushing product information to the user at a current time;
determining a to-be-pushed object from the candidate attribute set or the candidate product set based on the current push strategy, and generating current to-be-pushed information based on the to-be-pushed object; and
pushing the current to-be-pushed information.

32. The non-transitory computer readable medium of claim 31, wherein the current to-be-pushed object is determined by:
determining a recommendation score of each piece of product information in the candidate product set based on a user embedding vector, an embedding vector of each piece of product information in the candidate product set, and an embedding vector of attribute information represented by each effective attribute node, wherein the user embedding vector is generated based on a user portrait;
determining a recommendation score of each piece of attribute information in the candidate attribute set based on the recommendation score of each piece of product information in the candidate product set and an embedding vector of each piece of attribute information in the candidate attribute set; and
determining, in response to the push strategy being pushing the attribute querying information, a piece of attribute information with a highest recommendation score in the candidate attribute set as the current to-be-pushed object; or
determining, in response to the push strategy being pushing the product information, a piece of product information with a highest recommendation score in the candidate product set as the current to-be-pushed object.

33. The non-transitory computer readable medium of claim 31, wherein the operations further comprise:
deleting, in response to determining that feedback information of the user for the attribute querying information represents a rejection, an attribute in the attribute querying information from the candidate attribute set.

34. The non-transitory computer readable medium of claim 31, wherein the operations further comprise:
deleting, in response to determining that feedback information of the user for the pushed product information represents a rejection, the product information from the candidate product set.

35. The non-transitory computer readable medium of claim 31, wherein the extracting preference attributes of a user for a product from user dialogue information in a current dialogue scenario comprises:
opening, in response to receiving an instruction requesting to open a dialogue scenario, the current dialogue scenario, and acquiring the user dialogue information in the current dialogue scenario in real time; and
determining, in response to receiving information representing that the user actively confirms a product attribute, the product attribute in the information as a preference attribute; and determining, in response to determining that feedback information of the user for the attribute querying information represents an acceptance, an attribute in the attribute querying information as a preference attribute.

36. The non-transitory computer readable medium of claim 31, wherein the dialogue path is generated by:
determining, in response to receiving information that the user confirms a product attribute for a first time, the product attribute indicated by the information as an initial preference attribute;
determining an attribute node corresponding to the initial preference attribute in the knowledge graph as an initial node of the dialogue path; and
sorting the attribute nodes according to the dialogue time sequence by using the initial node as a start point to generate the dialogue path.
